(19) United States
(12) Patent Application Publication
(10) Pub. No.: US 2025/0256427 A1
(43) Pub. Date: Aug. 14, 2025

(54) PRINTING OF BARIUM TITANATE PASSIVE COMPONENTS FROM PRECURSOR COMPOUNDS

(71) Applicant: VQ RESEARCH, INC., Palo Alto, CA (US)

(72) Inventor: John Gustafson, Santa Clara, CA (US)

(21) Appl. No.: 18/774,894

(22) Filed: Jul. 16, 2024

Related U.S. Application Data
(60) Provisional application No. 63/551,558, filed on Feb. 9, 2024.

(51) Int. Cl. B28B 1/00; B33Y 10/00; B33Y 70/00; B33Y 80/00; C01G 23/00

(52) U.S. Cl. CPC B28B 1/001; B33Y 10/00; B33Y 70/00; B33Y 80/00; C01G 23/006

(57) ABSTRACT

Systems and methods for additive printing of barium titanate (BaTiO₃) components using precursors of barium titanate, i.e., barium carbonate (BaCO₃) and titanium dioxide (TiO₂), to prevent clogging of nozzles. Solid of barium carbonate and titanium dioxide are prepared by an electrical-assisted breakdown process, such as, e.g., milling, blending, and/or grinding. The assisted breakdown process allows for the reduction of particle size, thorough mixing, and consistent particle distribution of the precursors. In addition, the finer particles possess a much higher sinterability of the precursors while giving rise to denser final products. A planetary ball milling system with zirconia vial and balls at a fixed rotation speed may be used. The precursors are then printed into a green part. A solid-state reaction between barium carbonate and titanium dioxide to form barium titanate is activated by the application of heat, such as, e.g., through a sintering process, which forms the final product.

### FIELD OF TECHNOLOGY

This disclosure relates generally to printing of barium titanate passive components from precursor compounds to prevent clogging of print nozzles.

### BACKGROUND

Previously, passive electrical components have been mounted on a chip or created through photolithography; however, it has become possible to create passive components using additive manufacturing, also known as 3D Printing, where ink jets or aerosol jets deposit materials such as ceramic slurry, conductive ink, ferrite paste, and carbon resistor paste. This is an inherently more precise and repeatable process than traditional methods, and produces higher density components with less material waste. The materials just named can all be sintered at high temperatures, so they are amenable to integrated manufacture, which was previously not available in photolithography. Sintering of ceramic powder material provides an advantage over the prior art, such as, e.g., to produce an insulator layer that allows for an improvement in dielectric strength of approximately one thousand fold compared to previous procedures that can only print capacitors comprising films, e.g., a plastic film insulator layer.

### SUMMARY

Systems and methods for additive printing of barium titanate (BaTiO₃) passive components and integration in ceramic chip package using precursors of barium titanate, i.e., barium carbonate (BaCO₃) and titanium dioxide (TiO₂), to prevent clogging of print nozzles. For example, the component may include, e.g., multi-layer ceramic capacitors, inductors and/or resistors, and may be printed as stand-alone devices, or printed directly into the solid ceramic block of an integrated circuit that is used in its packaging. The ceramic block may still provide stiffness and strength, but in addition, it forms the matrix for the passive components. Solids of barium carbonate and titanium dioxide are prepared by an electrical-assisted breakdown process, such as, e.g., milling, blending, and/or grinding. The assisted breakdown process allows for the reduction of particle size, thorough mixing, and consistent particle distribution of the precursors. In addition, the finer particles possess a much higher sinterability of the precursors while giving rise to denser final products. For example, a planetary ball milling system with zirconia vial and balls at a fixed rotation speed may be used. The precursors are then printed into a green part. A solid-state reaction between barium carbonate and titanium dioxide to form barium titanate is activated by the application of heat, such as, e.g., through a sintering process, which forms the final product. Due to the non-ferroelectric property of the precursors, i.e., no electric charge, material buildup within a print nozzle of an additive printer does not occur, effectively preventing clogging of the nozzle.

Prior to printing of the components, and after the electrical-assisted breakdown process of the precursors, a suspension was prepared that comprises a solvent, plasticizer, binder, dispersant, and the precursors, i.e., barium carbonate and titanium dioxide. A solvent may be a liquid that is capable of dissolving one or more substances, such as, e.g., water; a plasticizer may be a substance that is added to the suspension to increase plasticity, such as, e.g., polyethylene glycol; a binder or binding agent may be any material or substance that holds the components of the suspension, such as, e.g., polyvinyl alcohol; and a dispersant may be used to keep particles in suspension, such as by coating particles of the precursors to give them the same charge to repel one another, such as, e.g., sodium pyrophosphate. The components are mixed together in a homogenous paste or slurry prior to printing.

### BRIEF DESCRIPTION OF THE DRAWINGS

Figures are illustrated by way of example and are not limited to the accompanying drawings, in which, like references indicate similar elements.

FIG. 1 is a typical surface-mount processor chip with discrete passive components.

FIG. 2 shows the various sizes of discrete multilayer ceramic capacitors.

FIG. 3 is a typical packaging of an integrated chip circuit chip. A typical “flip chip” packaging style is shown.

FIG. 4 is a schematic of an integration of passive components in a ceramic part of a chip packaging.

FIG. 5 is a system of an additive printer that may be used to manufacture a passive electrical component using precursors of barium titanate.

FIG. 6 is a flow diagram of an additive printing process that may be implemented to manufacture one or more passive components.

FIG. 7 is a flow diagram of a slurry preparation process that may be implemented to additively manufacture a passive component from barium titanate precursors.

### DETAILED DESCRIPTION

Although the present has been described with reference to specific examples, it will be evident that various modifications and changes may be made without departing from their spirit and scope. The modifications and variations include any relevant combination of the disclosed features. Equivalent elements, materials, processes or steps may be substituted for those representatively illustrated and described herein. Certain structures and features may be utilized independently of the use of other structures and features. In addition, the components shown in the figures, their connections, couplings, relationships, and their functions, are meant to be exemplary only, and are not meant to limit the examples described herein.

Systems and methods for additive printing of barium titanate passive components and integration in ceramic chip package using precursors of barium titanate, i.e., barium carbonate (BaCO₃) and titanium dioxide (TiO₂), to prevent clogging of print nozzles. For example, the component may include, e.g., multi-layer ceramic capacitors, inductors and/or resistors, and may be printed as stand-alone devices, or printed directly into the solid ceramic block of an integrated circuit that is used in its packaging. The ceramic block may still provide stiffness and strength, but in addition, it forms the matrix for the passive components. Solids of barium carbonate and titanium dioxide are prepared by an electrical-assisted breakdown process, such as, e.g., milling, blending, and/or grinding. The assisted breakdown process allows for the reduction of particle size, thorough mixing, and consistent particle distribution of the precursors. In addition, the finer particles possess a much higher sinterability of the precursors while giving rise to denser final products. For example, a planetary ball milling system with zirconia vial and balls at a fixed rotation speed may be used. The precursors are then printed into a green part. A solid-state reaction between barium carbonate and titanium dioxide to form barium titanate is activated by the application of heat, such as, e.g., through a sintering process, which forms the final product. Due to the non-ferroelectric property of the precursors, i.e., no electric charge, material buildup within a print nozzle of an additive printer does not occur, effectively preventing clogging of the nozzle.

The reaction to form barium titanate from the stoichiometric solid-state reaction of barium carbonate and titanium dioxide is shown in the equation below:

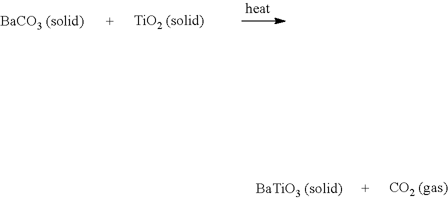

In summary, barium carbonate and titanium dioxide reacts to form the products barium titanate and carbon dioxide with the application of heat. Carbon dioxide outgasses and is removed from the remaining product.

Prior to printing of the components, and after the electrical-assisted breakdown process of the precursors, a suspension was prepared that comprises a solvent, plasticizer, binder, dispersant, and the precursors, i.e., barium carbonate and titanium dioxide. A solvent may be a liquid that is capable of dissolving one or more substances, such as, e.g., water; a plasticizer may be a substance that is added to the suspension to increase plasticity, such as, e.g., polyethylene glycol; a binder or binding agent may be any material or substance that holds the components of the suspension, such as, e.g., polyvinyl alcohol; and a dispersant may be used to keep particles in suspension, such as by coating particles of the precursors to give them the same charge to repel one another, such as, e.g., sodium pyrophosphate. The components are mixed together in a homogenous paste or slurry prior to printing.

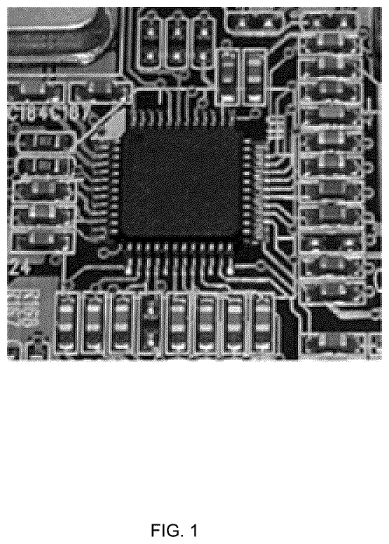

FIG. 1 is a typical surface-mount processor chip with discrete passive components. The dark square in the center is a processor chip made from a semiconductor and encased in ceramic (the “chip package”) that protects the chip from moisture. Surrounding that chip are two-electrode devices, such as, e.g., mostly multi-layer ceramic capacitors (MLCCs).

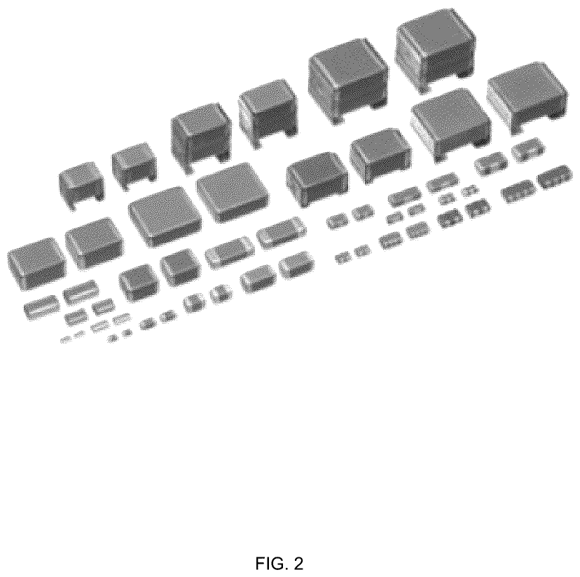

FIG. 2 shows the various sizes of discrete multilayer ceramic capacitors. MLCCs are currently manufactured as discrete components in a wide range of sizes and specifications. Even the smallest MLCC in general use may be millions of times larger than the transistors in integrated devices. That is one reason they are difficult to integrate lithographically. Another reason is that the ceramic material in an MLCC is made with a high-temperature process that would destroy the devices that are created lithographically. Therefore, efforts to integrate passive components have, to date, focused on placing them on the semiconductor wafer prior to packaging.

Plastic or ceramic packaging involves mounting a die, connecting die pads to the pins on the package, and sealing the die. Tiny wires are used to connect the pads to the pins. Traditionally, these wires comprise gold leading to a lead frame of solder-plated copper.

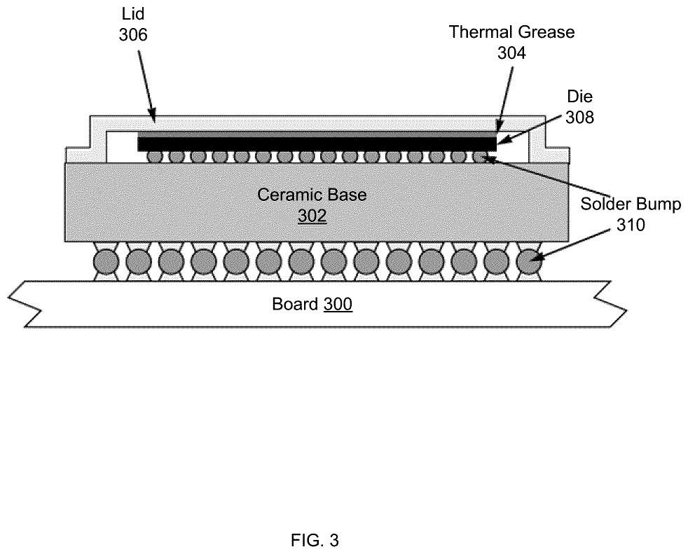

FIG. 3 is a typical packaging of an integrated chip circuit chip. A typical “flip chip” packaging style is shown. Board 300 may be a multilayer printed circuit board similar to that shown holding the components in FIG. 1. Discrete components such as, e.g., MLCCs, are mounted separately through conductive paths printed on board 300. Ceramic base 302 may comprise an ordinary ceramic material, formed by high temperature sintering; it provides mechanical strength and stiffness, since any flexing might break electrical connections. Thermal grease 304 may be applied between lid 306 and circuit die 308. Lid 306 may encapsulate die 308 to protect and insulate die 308 from the outside environment. Board 300 and die 308 may both be coupled to ceramic base 302 by an array of solder bump 310.

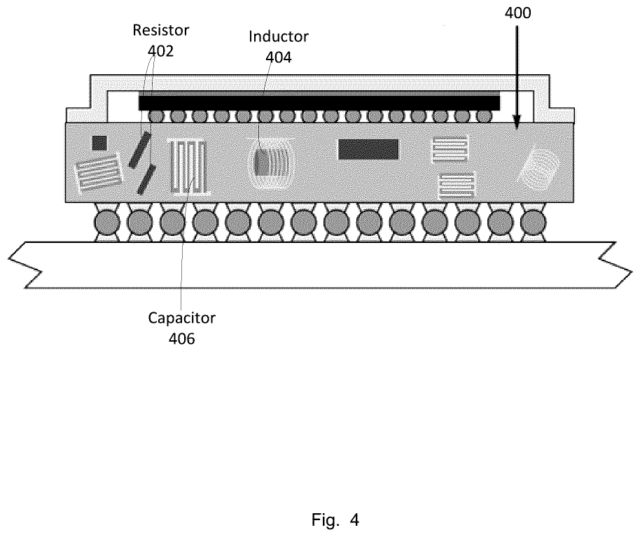

FIG. 4 is a schematic of an integration of passive components in a ceramic part of a chip packaging. In the present figure, depth dimension, component interconnects, components to PCB connections, and conductive shieldings were omitted for clarity. Ceramic matrix 400 may comprise resistor 402 represented by a dark rectangle, inductor 404 represented by a helical shape (with or without a ferrite core), and capacitor 406 represented by a multilayer zig-zag shape. They are shown in different proportions and in different angles to emphasize that the orientation and form factors of the passive elements are highly flexible and not constrained to being axis-aligned. Their individual geometries can be curved, warped, zig-zag or any other shape. One advantage of being able to angle the components is that it provides control of the parasitic effects the components have on each other and on the devices within the chip.

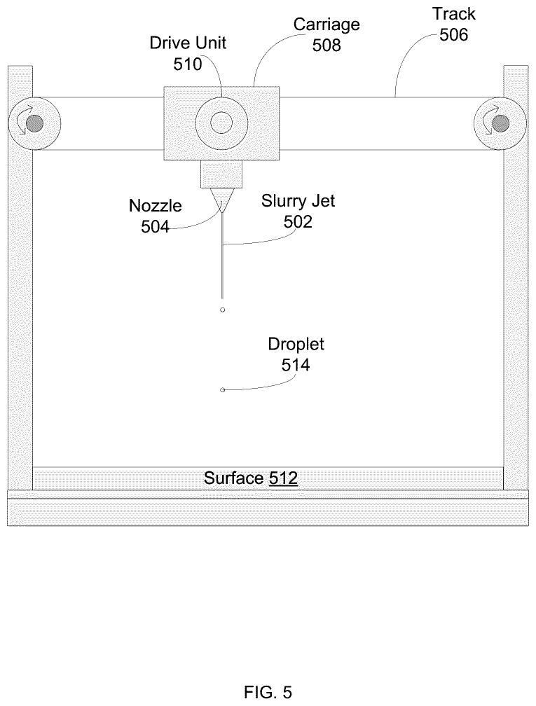

FIG. 5 is a system of an additive printer that may be used to manufacture a passive electrical component using precursors of barium titanate. The component may be a stand-alone device, or integrated within a ceramic chip packaging. Any other type of additive printer may be used. A slurry jet 502 may be dispensed from a nozzle 504 having an orifice comprising an opening, and may be raster or vector scanned on track 506 by a carriage 508 driven by drive unit 510 over a surface 512, or on top of an already formed powder bed to define a new layer. Pressure may be used to force the slurry out of nozzle 504 and into a continuous stream of slurry jet 502 and/or as droplet 514, which may be defined as a breakup of the flow. A layer surface height measurement unit, such as, e.g., a laser rangefinder may be used to receive an input signal to control the height of the surface that is formed by varying the delivery of slurry.

A typical implementation of an additive manufacturing process begins with defining a three-dimensional geometry of the product using computer-aided design (CAD) software. This CAD data is then processed with software that slices the model into a plurality of thin layers, which are essentially two-dimensional. A physical part is then created by the successive printing of these layers to recreate the desired geometry. This process is repeated until all the layers have been printed. Typically, the resulting part is a “green” part, which may be an unfinished product that can undergo further processing, e.g., sintering. The green part may be dense and substantially non-porous.

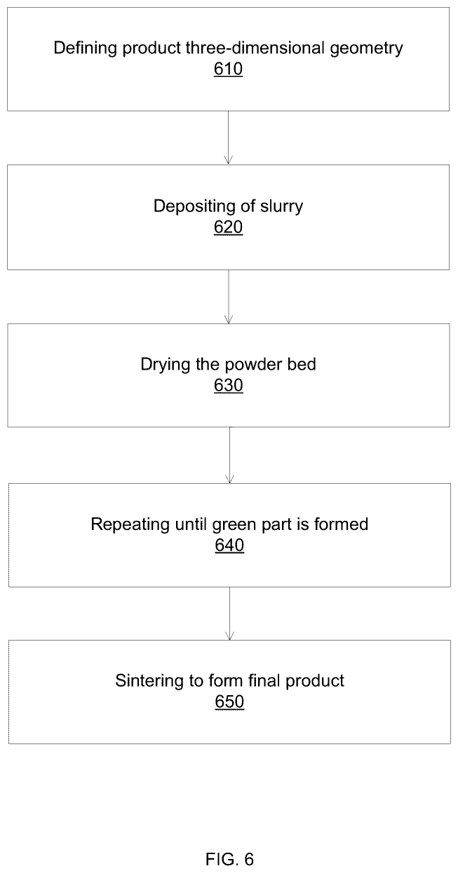

FIG. 6 is a flow diagram of an additive printing process that may be implemented to manufacture one or more passive components. The components may be stand-alone devices, or integrated within a ceramic chip packaging. Operation 610 defines a final product's three-dimensional geometry using CAD software. Operation 620 deposits layers of slurry comprising powder material and binder onto a surface or on top of a powder bed, which then slip-casts to make a new layer. As the slurry deposits in each two dimensional layer, the printer may select insulator or conductor as the material type, in separate passes or as a combined pass. The slurry may be deposited in any suitable manner, including depositing in separate, distinct lines, e.g., by raster or vector scanning, by a plurality of simultaneous jets that coalesce before the liquid slip-casts into the bed, or by individual drops. The deposit of slurry drops may be individually controlled, thereby generating a regular surface for each layer. Operation 630 dries any liquid from the powder bed, e.g., infrared flash-dry, after deposition of each layer. Operation 640 repeats operations 610 to 640 until a green part is formed. Operation 650 sinters the green part to form a final product. Sintering is a solid-state diffusion process that may be enhanced by increasing the surface area to volume ratio of the powder in any green part that is subsequently sintered.

Due to the non-ferroelectric property of the precursors, i.e., no electric charge, material buildup within a print nozzle of an additive printer does not occur, effectively preventing clogging of the nozzle.

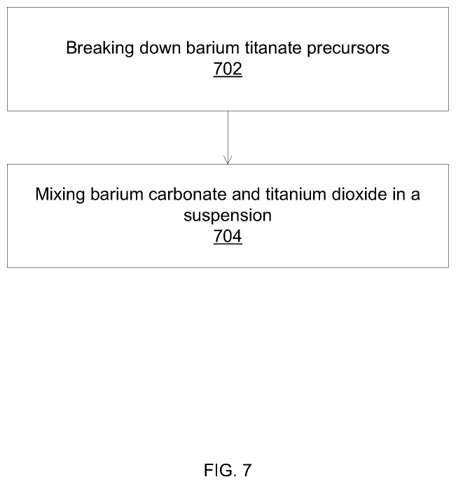

FIG. 7 is a flow diagram of a slurry preparation process that may be implemented to additively manufacture a passive component from barium titanate precursors. The component may become a stand-alone device, or integrated within a ceramic chip packaging. Operation 702 breaks down solids of barium carbonate and titanium dioxide by an electrical-assisted process, such as, e.g., milling, blending, and/or grinding. The assisted breakdown process allows for the reduction of particle size, thorough mixing, and consistent particle distribution of the precursors. In addition, the finer particles possess a much higher sinterability of the precursors while giving rise to denser final products. Operation 704 mixes the barium carbonate and titanium dioxide particles in a solution comprising a solvent, plasticizer, binder, and dispersant. A solvent may be a liquid that is capable of dissolving one or more substances, such as, e.g., water; a plasticizer may be a substance that is added to the solution to increase plasticity, such as, e.g., polyethylene glycol; a binder or binding agent may be any material or substance that holds the components of the solution, such as, e.g., polyvinyl alcohol; and a dispersant may be used to keep particles in suspension, such as by coating particles of the precursors to give them the same charge to repel one another, such as, e.g., sodium pyrophosphate. The components are mixed together in a homogenous paste or slurry prior to printing.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added or removed. Accordingly, other examples are within the scope of the following claims.

What is claimed is:

1. A method, comprising:
preparing a ceramic slurry;
defining a three-dimensional geometry of an electrical passive component;
depositing at least one layer of slurry comprising barium carbonate and titanium dioxide particles on top of a powder bed;
drying the powder bed after deposition of each layer when more than one layer is deposited; and
sintering the one or more layers to form the electrical passive component.

2. The method of claim 1:
wherein preparing the ceramic slurry comprises breaking down solids of barium carbonate and titanium dioxide;

3. The method of claim 2:
wherein breaking down solids of barium carbonate and titanium dioxide comprises using an electric-assisted device.

4. The method of claim 1:
wherein preparing the ceramic slurry comprises mixing a suspension comprising barium carbonate and titanium dioxide.

5. The method of claim 4:
wherein mixing the suspension comprises adding a solvent.

6. The method of claim 5:
wherein mixing the suspension comprises adding a plasticizer.

7. The method of claim 6:
wherein mixing the suspension comprises adding a binder.

8. The method of claim 7:
wherein mixing the suspension comprises adding a dispersant.

9. The method of claim 1:
wherein sintering of the one or more layers activates a solid-state reaction between barium carbonate and titanium dioxide particles to form barium titanate.

10. The method of claim 1:
wherein the electrical passive component comprises a multi-layer ceramic capacitor.

11. The method of claim 1:
wherein the electrical passive component comprises an inductor.

12. The method of claim 1:
wherein the electrical passive component comprises a resistor.

13. The method of claim 1:
wherein the electrical passive component is a stand-alone device.

14. The method of claim 1:
wherein the electrical passive component is integrated within a ceramic chip packaging

15. A method of claim 14:
wherein the ceramic chip packaging is formed along with the electrical passive component.
